(19) United States
(12) Patent Application Publication
(10) Pub. No.: US 2007/0097505 A1
(43) Pub. Date: May 3, 2007

(54) Illuminated signaling device

(76) Inventor: Charmaine Desjardin, Duluth, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/263,438

(22) Filed: Oct. 31, 2005

(51) Int. Cl. G02B 5/12

(52) U.S. Cl. 359/515; 359/527

(57) ABSTRACT

Signaling devices are for enhancing the visibility of an object or location. The signaling device has a first layer, a reflective layer, and a plurality of lights electrically connected to a power source. The signaling device has a mounting mechanism located at a plurality of locations on the first layer for securing the signaling device to an object such as a tree or disabled vehicle. The mounting mechanism may be grommets, magnets, hook and loop fasteners, or any combination thereof. The lights are attached to the reflective layer and positioned within an aperture of a protective cover such that the light does not protrude past an outer surface of the protective cover. The reflective layer may be removable. The signaling device may include an audible alarm.

### RELATED APPLICATIONS

This patent application is related to non-provisional U.S. patent application Ser. No. 11/171,715 (Attorney Docket No. 60009.0001US01) entitled, “Versatile Garment for Enhancing the Safety of Personnel in Low-Light Conditions” filed on Jun. 30, 2005, which is expressly incorporated herein by reference.

### FIELD OF THE INVENTION

Embodiments of the invention relate generally to the field of safety flags and safety devices. More particularly, embodiments of the invention relate to a signaling device for enhancing the visibility of an object to which the signaling device is attached.

### BACKGROUND OF THE INVENTION

It is often desirable, and sometimes even required by law, to draw attention to a particular object or situation in order to enhance the safety of persons in close proximity to the object or situation. For example, when an object loaded in a vehicle extends out from the rear of the vehicle a certain distance, local statutes often require a safety flag to be attached to the end of the load to ensure that drivers behind the loaded vehicle are aware of the potential danger. These safety flags often take the form of red or orange cloth, flags manufactured from brightly colored or reflective material, or placards secured to the load. The same applies to vehicles carrying extra wide loads.

Similarly, safety flags or other types of warning signals are often used to draw attention to highway workers or drivers with disabled vehicles on the side of a road. For highway workers, large diamond-shaped warning signs are often placed in stands along the side of the road and are sometimes accompanied by brightly colored flags. For situations involving disabled vehicles, drivers often carry warning signs, such as small brightly colored reflective triangles to place alongside the road to warn other drivers that a disabled vehicle is ahead. However, most of these warning signs are not visible at night, without direct light from an outside source such as vehicle headlights reflecting off of the surface of the warning sign. Some of the large signs used by highway workers include a single large beacon light, but these signs are very large and cumbersome, requiring a rigid stand to hold the sign in place.

There are other situations where it is useful to be able to mark a location using highly visible means. Hikers, hunters, and surveyors often want to mark a particular location. A hiker who does not want to get lost or who wants to point out a particular route to another hiker might mark a tree with paint or ribbon, or insert a flag or stake in the ground. Similarly, hunters who want to identify a particular area for another hunter might do the same. Surveyors often mark trees and other locations using paint.

There are a couple of problems with these marking methods. First, although the methods employed by hikers, hunters, surveyors, and others to mark a location are useful in that they often provide the desired visibility, their utility decreases as ambient light decreases. As it gets dark, paint, ribbons, flags, and stakes are more difficult to see, even if brightly colored and even reflective. Second, some of these methods, such as using paint, are destructive and permanent. Therefore, it is highly desirable to have a portable, non-destructive, temporary signaling device that is highly visible under all ambient light conditions that may be used in any situation where it is desirable to draw attention to an object or situation.

It is with respect that, these and other considerations that the various embodiments of the present invention have been made.

### SUMMARY OF THE INVENTION

Aspects of the present invention address these problems and others by providing a signaling device that provides enhanced visibility in low-light conditions through incorporating self-illumination features, provides versatility through multiple mounting mechanisms at multiple locations on the device, provides versatility through multiple configurations that allow a user to alter the arrangement of reflective tape and lights, and provides portability through flexible materials that allow for compact folding and storage.

According to one aspect of the present invention, a signaling device has first and second layers, the second layer attached to the first layer and having a reflectance greater than the first layer. The first layer has a mounting mechanism located at more than one location on the first layer for securing the signaling device to an object. The signaling device additionally has a plurality of lights electrically connected to a power source receiving means.

According to another aspect of the present invention, a signaling device has a first layer and a second layer detachably connected to the first layer. A mounting mechanism is located at a plurality of reinforced locations on the first layer for securing the signaling device to an object. A plurality of light emitting diodes (LEDs) are attached to the second layer, each LED being electrically connected to a means for receiving a power source.

A further aspect of the present invention includes a signaling device with a mesh layer and a reflective tape layer detachably connected to the mesh layer. At least one magnet and at least one grommet are fixed to the signaling device for securing the signaling device to an object. A plurality of LEDs are attached to the reflective tape layer. Each of the LEDs is electrically connected to a means for receiving a power source located within the reflective tape layer.

These and various other features as well as advantages, which characterize the present invention, will be apparent from a reading of the following detailed description and a review of the associated drawings. It is to be understood that both the foregoing general description and the following detailed description are exemplary and explanatory only and are not restrictive of the invention, as claimed.

### BRIEF DESCRIPTION OF THE DRAWINGS

FIG. 1 is a top view of a signaling device illustrating a reflective strip with LEDs and signaling device mounting mechanism in accordance with one embodiment of the present invention;

FIG. 2 is a partially exploded top view of a signaling device illustrating a detachable reflective strip with LEDs and signaling device mounting mechanism in accordance with one embodiment of the present invention;

FIGS. 2A-2D are top views of LED patches for use with the signaling device of FIG. 2;

FIG. 3 is a front view of a signaling device attached to a tree or pole illustrating a signaling device utilized for marking a location in accordance with one embodiment of the present invention;

FIG. 4 is a perspective view of a signaling device attached to an extended vehicle load illustrating a signaling device utilized to draw attention to an object in accordance with one embodiment of the present invention;

FIG. 5 is a perspective view of a signaling device magnetically attached to a vehicle illustrating a signaling device utilized to draw attention to a disabled vehicle in accordance with one embodiment of the present invention;

FIG. 6A is a side view of a LED within a protective cover in accordance with one embodiment of the present invention; and

FIG. 6B is a top view of a LED within a protective cover in accordance with one embodiment of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Being able to draw attention to a specific person, place, or situation is essential to the safety of many individuals. People who experience a flat tire or other mechanical problem with their vehicle need a portable signaling device for warning other drivers of the location of the disabled vehicle while they change the tire or wait for help. Drivers with cargo extending outward from the back of their vehicles or drivers with wide loads need a signaling device that is easily attached to their cargo to alert other drivers of the potential dangers associated with the oversized load. Hikers, hunters, and others have a need for marking a particular location on a trail or in the woods. Aspects of the present invention provide improved signaling devices to alert others of potentially hazardous situations or to mark a specific location or object. Signaling devices according to aspects of the present invention are versatile, portable, and highly visible, allowing persons to easily store, transport, and display the signaling device under a variety of conditions and situations.

Signaling devices according to aspects of the present invention provide users with the ability to provide increased visibility to an object in low light conditions utilizing self-illumination, without relying on reflecting light from sources outside of the device. The signaling device illumination sources are protected, increasing the durability and life of the device. According to various embodiments, the device provides audible alarms in addition to visual illumination, detachable illumination, non-visible light illumination, as well as various lighted detachable patterns, symbols, messages, beacons, and identification.

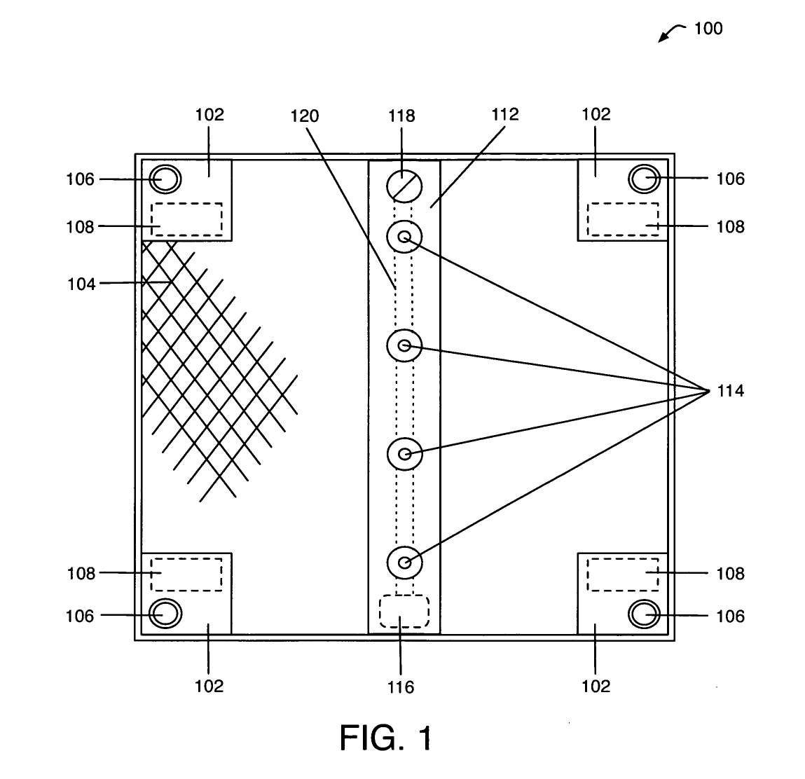

FIG. 1 illustrates a top view of a signaling device 100 according to one embodiment of the present invention. Signaling device 100 is shown throughout the figures as having four sides and being generally rectangular in shape, however it is to be understood that signaling device may be any shape with any dimensions. Signaling device 100 is preferably made from mesh 104. Mesh 104 allows for air penetration when signaling device 100 is used on cargo extending from a moving vehicle, minimizing damage to the signaling device and improving durability. Mesh 104 also minimizes the weight of device, which is an important aspect to hikers, hunters, and any others who might carry signaling device 100 for long distances. For clarity, only a portion of signaling device 100 shown in FIG. 1 and other figures is shown as mesh 104, but it is to be understood that the entire surface may be mesh.

Mesh 104 may be a bright color to provide a sharp contrast with the surrounding environment in order to attract attention. Suitable colors include but are not limited to neon orange, neon green, or neon yellow. All materials are flame retardant. While the material of mesh 104 may be rigid, it is preferable that the mesh be manufactured from any suitable flexible material, allowing signaling device 100 to be folded or rolled up. Folding or rolling signaling device 100 minimizes the footprint of the device and allows it to be stored and transported with minimal required space. Signaling device 100 should be of a size, when folded or rolled, that it will readily fit inside an emergency vehicle kit, within a spare tire compartment, or under or behind a vehicle seat.

In an alternate embodiment of the present invention, signaling device 100 includes a pouch sewn to the mesh 104. The pouch may be made from any material and secured in any location on device 100, either permanently or detachably. Signaling device 100 may be folded into the pouch to minimize the size of device 100 when not in use and to facilitate carrying. Securing means such as VELCRO loops may be incorporated on the exterior of the pouch to allow the device 100 to be attached to a belt or belt loop when stored in the pouch. The pouch may alternatively be used to carry survival packs, first aid kits, or items such as spare batteries or flashlights. Additional pouches may be incorporated on device 100 for these purposes.

Signaling device 100 includes reinforced corners 102. FIG. 1 shows a signaling device 100 with four corners, each corner having reinforcement to support any number of mounting mechanisms. As stated above, signaling device 100 may include any number of corners, or no corners at all if shaped like a circle or ellipse. It is preferable that each corner be reinforced for attachment means, but it is within the scope of this invention to locate the attachment means at any one or more of the corners or at any location on signaling device 100 other than the corners.

Reinforced corners 102 operate to strengthen mesh 104 at locations where mechanisms for mounting the signaling device 100 to external objects are located. Reinforced corners 102 are two nylon pieces of material sewn together such that mesh 104 is sandwiched between the two pieces of material. It should be appreciated that any material may be used to reinforce the corners. The material is preferably anti-static, but may contain any characteristics as long as the material is suitable for adding strength to the corners of the signaling device 100. Alternatively, the mounting locations on the signaling device 100 may be reinforced using only a single piece of reinforcement material or by using a hardening solution applied to the mesh 104. Reinforcement material may not only be sewn to the mesh 104, but also welded to the mesh or secured to the mesh using adhesive.

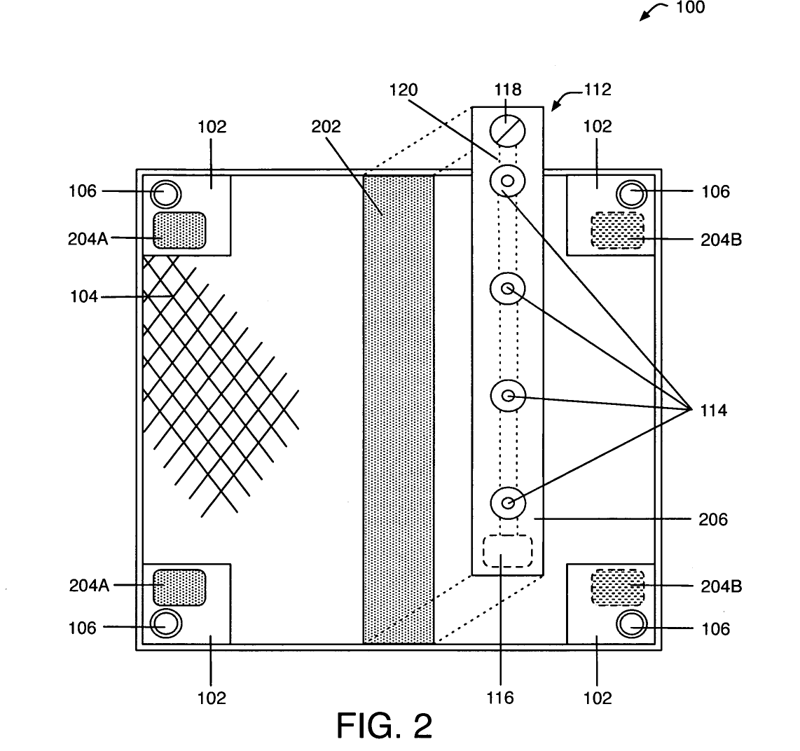

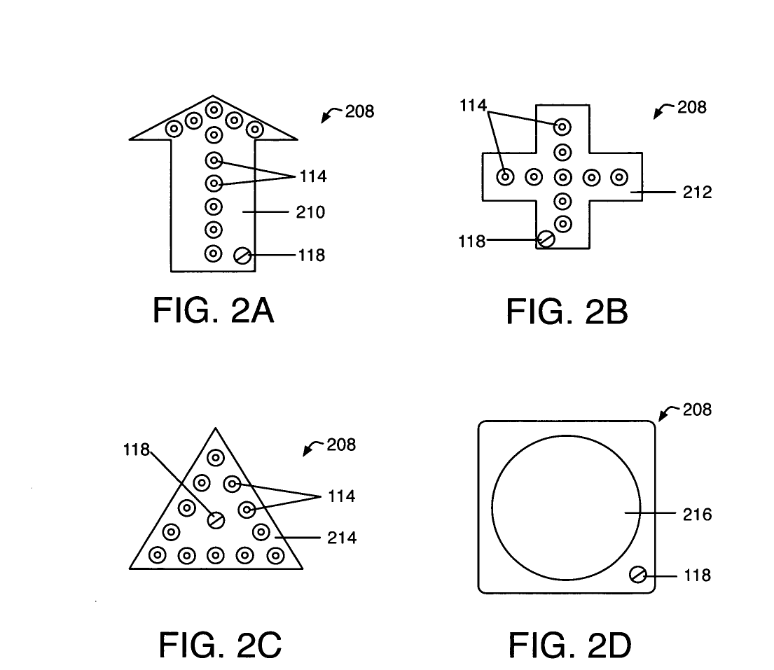

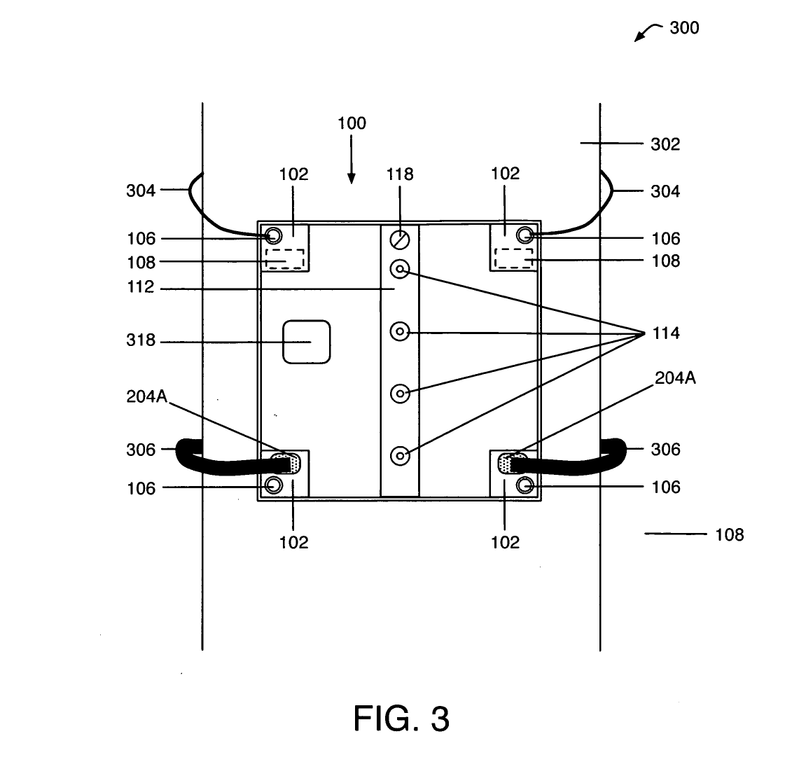

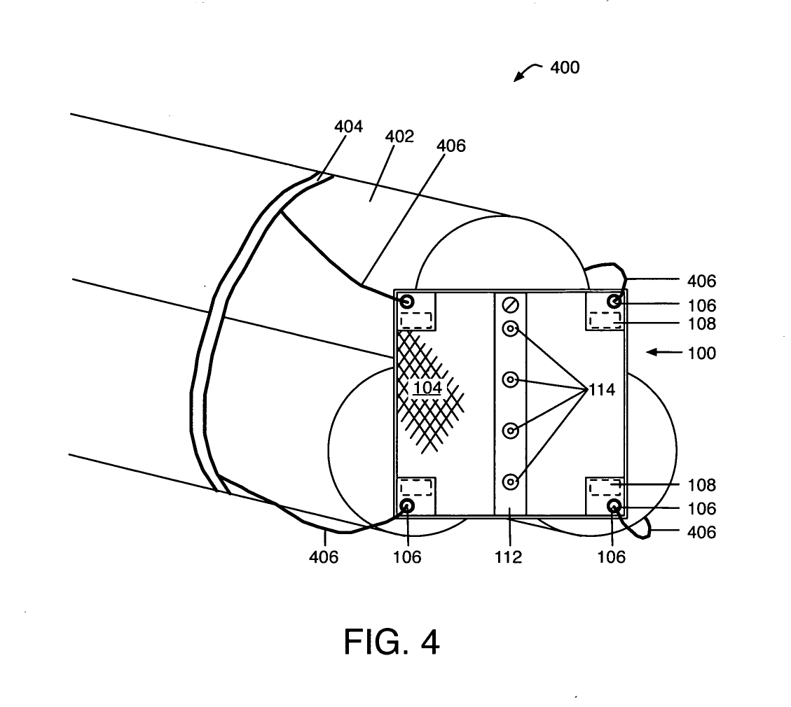

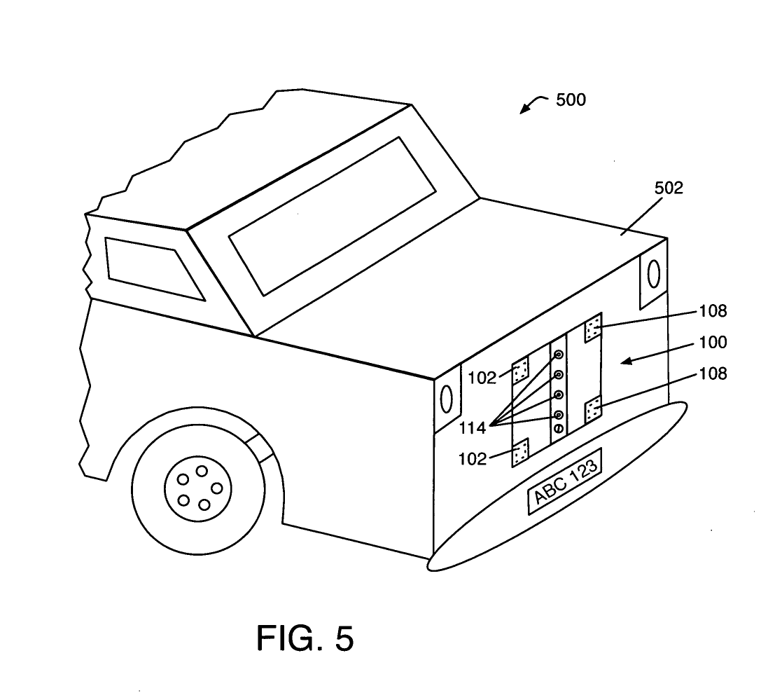

Signaling device 100 is versatile, allowing a user to secure the device to virtually any object using any one of multiple mounting mechanisms. One such mounting mechanism includes grommets 106. Grommets 106 are preferably made from metal for durability purposes, but may be plastic, nylon, or any type of material now known or developed in the future. Grommets 106 may be used to tie the signaling device 100 to an object as shown in FIGS. 3 and 4, which are discussed below. Reinforced corners 102 also contain magnets 108. Magnets 108 are sewn into each reinforced corner 102 and are used to secure signaling device 100 to a metal surface as discussed below with respect to FIG. 5. Additionally, hook and loop fasteners such as VELCRO may be attached to reinforced corners 102 to provide additional means for attaching signaling device 100 to an object. Attachment means are discussed below with respect to FIGS. 2 and 3. Additional mounting mechanisms may be incorporated into signaling device 100, including but not limited to snaps, buttons, and zippers.

Signaling device 100 has a reflective strip 112 attached to the mesh 104. Reflective strip 112 adds to the visibility of the device 100 since it has a reflectance that is greater than that of the mesh 104. Because reflective strip 112 reflects more light than mesh 104, it is more easily seen in low-light conditions with the aid of an outside light source such as the headlights of an automobile or a flashlight. Reflective strip 112 may be reflective tape that is sewn or otherwise permanently attached to mesh 104. Alternatively, reflective strip 112 may be detachably attached to the device 100 as described below with respect to FIG. 2. Preferably, reflective strip 112 is a bright color that contrasts not only the surrounding environment, but also contrasts the color of mesh 104. As an example, mesh 104 may be neon orange, while reflective strip 112 is neon yellow. By using contrasting colors, more attention is drawn to the signaling device 100. It is to be understood, however, that mesh 104 and reflective strip 112 may be any color, including the same color.

While the colors of mesh 104 and reflective strip 112 draw attention to the signaling device 100 in daylight conditions, it is the increased reflectance of reflective strip 112 that enhances the safety of the user in low-light or nighttime conditions. In low-light conditions, lights that shine on reflective strip 112 are reflected, making strip 112 more perceptible than the surrounding environment. This increased reflectance is of great benefit to the user when located within close proximity to the path of an oncoming vehicle since the headlights of the vehicle will likely be reflected off of reflected strip 112 back to the driver of the vehicle, alerting the driver of any potentially dangerous situation marked by the signaling device 100. Reflective strip 112 meets American National Standards Institute (ANSI) standards.

To ensure that the signaling device 100 is seen at night without having to depend on reflected light from the headlights of the vehicle or someone's flashlight, the signaling device 100 includes a plurality of self-illuminating light assemblies 114. As seen in FIG. 1, light assemblies 114 are spaced apart along reflective strip 112. It should be appreciated that any number and location of light assemblies 114 may be used. Wires 120 electrically connect each light 114 to power source 116, located within reflective strip 112. Power source 116 is preferably common low-profile batteries such as those used in watches. It should be understood that any number, type, or size of batteries sufficient to provide power to light assemblies 114 may be used depending on the number and type of lights connected to the power source. It should also be appreciated that alternate power sources may also be used such as solar power cells electrically connected to solar panels secured to the signaling device 100.

The electrical circuit comprised of the light assemblies 114, power source 116, and connecting electrical wires 120 further includes on/off button 118. On/off button 118 is secured at a location within reflective strip 112 such that a user presses a marked location on a reflective strip to compress button 118 within the reflective strip in order to activate and deactivate the light assemblies 114. Reflective strip 112 comprises at least a top reflective surface and a backing. The on/off button 118 and the wiring 120 connecting light assemblies 114 to the on/off button 118 and power source 116 are located between the top reflective surface and the backing of reflective strip 112. By locating the electrical components within reflective strip 112, the circuit components are hidden and protected from damage due to ordinary wear and tear from use of the signaling device. It is to be understood that on/off button 118 could protrude through a reflective strip 112, be a toggle or rocker switch, or be located on or proximate to the power source 116. By placing the on/off button 118 within a reflective strip on the front of the signaling device 100, the user has easy access to the button, while the button remains protected for durability and water-resistant purposes.

It is also to be understood that the light assemblies 114 and corresponding wiring and circuitry may be located on device 100 separate from reflective strip 112. In an alternate configuration in which the light assemblies 114 are located on reflective strip 112 but the power source 116 is located elsewhere on signaling device 100, the electrical wiring exits reflective strip 112 through an aperture to connect to power source 116. Signaling device 100 may be water-resistant or water-proof if the electrical components are sealed and protected from moisture intrusion by means known in the art.

As one skilled in the art will appreciate, light assemblies 114 may be wired such that all lights remain on in a steady state, flash simultaneously in a regular on and off pattern, flash simultaneously in a pattern of any number of quick flashes followed by an off state of longer duration before repeating the pattern of quick flashes, flash in any type of regular or irregular pattern to include Morse Code or any other type of communicative code, flash in a programmed or random sequence, or any combination or variation thereof. The known circuitry for controlling the lights is located within a small box containing the power source 116 but may be located anywhere on signaling device 100. The lights in light assemblies 114 are preferably LEDs, but any other light source may be used. The lights in light assemblies 114 may be any color including red, blue, green, yellow, white, orange, or any combination thereof.

In an alternative embodiment, light assemblies 114 emit non-visible light such as infra-red or ultraviolet. In doing so, the device 100 may be used by military personnel and hunters who wish to maintain stealth while remaining in visual contact with one another or to mark a particular location for another to find. By using night-vision goggles, binoculars, or a monocular as known in the art designed to detect light with wavelengths in the non-visual range on an electromagnetic spectrum, signaling device 100 may be seen and distinguished from the surrounding environment by the flashing lights that are unable to be seen by the naked eye.

FIG. 2 shows a signaling device 100 with a detachable reflective strip 112 according to one embodiment of the present invention. Signaling device 100 includes attach means 202 and detachable reflective strip 112. This embodiment allows a user to reconfigure signaling device 100 with reflective strips 112 and light assemblies 114 of varying colors and configurations. Users may optionally add illuminated messages, identification, or beacons to the device. This feature allows a person to use the signaling device 100 in a number of situations and to alter the configuration of the device depending on the specific requirements of the given task. Attach means 202 may be a hook or loop patch, such as VELCRO, sewn or otherwise permanently attached to the mesh 104. The detachable reflective strip 112 would have a corresponding hook or loop patch backing so as to quickly attach to device 100. Additional attach means 202 includes but is not limited to snaps, buttons, zippers, tape, or any other means that would allow a reflective strip 112 or other LED patch 208 to be secured and removed. It is also to be understood that in alternate embodiments of the present invention, reflective strip 112 or LED patch 208 may be permanently secured to mesh 104 using stitching or adhesive such that the strip or patch may not be removed.

Reflective strip 112 shown in FIG. 2 has LED configuration 206, which comprises four LEDs 114 and on/off button 118. To power the LEDs 114, the reflective strip would preferably include its own power source 116 and provide space between the top reflective surface and the backing of the reflective material to house the circuitry associated with the LEDs. Alternatively, power source 116 may be secured to mesh 104 and include electrical wiring from power source 116 to a terminating plug. Electrical wiring 120 within reflective strip 112 would terminate at a connector configured to mate with the terminating plug on mesh 104 to complete the circuit.

FIGS. 2A-2D illustrate examples of additional LED patches 208 that may be used with the device embodiment shown in FIG. 2. FIG. 2A shows a patch 208 with LEDs configured in the shape of an arrow 210. This configuration is useful for directing traffic in one direction, i.e. around an accident, or to point hikers or rescue personnel in a particular direction. This patch and all others described here might also include magnets, grommets, and hook and loop fasteners for independently attaching the patch 208 to an object without using the non-illuminating portion of signaling device 100. FIG. 2B shows a patch 208 in a cross configuration 212 to indicate medical personnel, or if rotated 45 degrees, patch 208 may be used as an “X” to identify a particular location or object. FIG. 2C shows a patch 208 in a warning triangle configuration 214. Finally, FIG. 2D shows a patch 208 with beacon light 216. This patch includes a single large beacon light to further draw attention to the signaling device 100. The configurations of patch 208 is not limited to the those shown in FIGS. 2A-2D. Any patch configuration or reflective strip 112 with any number and color of LEDs may be used to customize the signaling device 100 for a any given application.

Referring back to FIG. 2, signaling device 100 may include further mounting mechanisms at reinforced corners 102. Specifically, in addition to grommets 106 and magnets 108, VELCRO fasteners 204 may be secured to each reinforced corner 102. Hook fasteners 204A are attached to signaling device 100 at each reinforced corner on a front side of the device while loop fasteners 204B are attached to the signaling device at each corner on a rear side of the device. For clarity, only two hook fasteners 204A and two loop fasteners 204B are shown in FIG. 2, but it should be understood that each reinforced corner 102 could have hook fasteners 204A attached on one side of signaling device 100 and loop fasteners 204B on the other side of the signaling device. By placing hook fasteners 204A on the front of signaling device 100 and loop fasteners 204B on the back of the device, a user is presented with several more options for attaching the device 100 to an object. First, signaling device 100 may be wrapped around an object such that one edge of the signaling device overlaps an opposite parallel edge of the device, allowing loop fasteners 204B proximate to one edge of the device to engage hook fasteners 204A proximate to the opposite parallel edge of the signaling device. Other options for mounting signaling device 100 to an object are shown in FIG. 3.

VELCRO fasteners 204 also serve to facilitate storage of signaling device 100. To store the device, a user may remove reflective strip 112 from VELCRO attach means 202 and attach it to corresponding VELCRO fasteners 204 along one edge of signaling device 100. Starting with the same edge to which reflective strip 112 is now attached, the user may roll signaling device 100 from front to back up to the VELCRO attach means 202. The user then wraps the opposite edge of signaling device 100 around the roll and attaches the remaining VELCRO fasteners 204 to VELCRO attach means 202 or to other VELCRO strips attached to the signaling device 100 for this purpose in order to secure the signaling device in a rolled configuration.

FIG. 3 illustrates marking scenario 300 in which a signaling device 100 is attached to a tree 302 in order to mark a location. Hikers and hunters, as well as others, often desire to mark a location along a trail or in the woods to identify a location for other hikers or hunters. One method of attaching the signaling device to tree 302 is using the VELCRO fasteners 204 described above with respect to FIG. 2. A VELCRO strip 306 is used to wrap around the tree 302 and engage hook fasteners 204A located on the front of signaling device 100. Similarly, a VELCRO strip 306 could be used to wrap around the tree 302 and engage loop fasteners 204B on the rear of signaling device 100. Another method for attaching signaling device 100 to tree 302 is using string or rope 304 connected to grommets 106.

Another feature of a signaling device 100 according to one embodiment of the present invention that enhances the location marking capabilities of the signaling device is audible device 318, shown in FIG. 3. Audible device 318 may be any device that produces an audible tone of sufficient volume to alert others of the location of the signaling device. Audible devices 318 may include an alarm as known in the art that produces a steady tone, an intermittent tone, or a voice recording. Audible devices 318 are secured to device 300 permanently through stitching, detachably through any of the fastening means discussed above, or in a pouch stitched to device 300. Using both the audible device 318 and LEDs 114, a person lost in the woods would increase the chance of early rescue by alerting others both audibly and visually to their location.

FIG. 4 shows extended load scenario 400 in which a signaling device is attached to an extended vehicle load 402 to caution other drivers of the potential danger. In this embodiment, one end of string or rope 406 is tied to grommets 106 on signaling device 100 with the opposing end of string or rope 406 tied to strap 404 to secure the signaling device to the extended load. Through bright colors, reflective strip 112, and LEDs 114, signaling device 100 draws attention to the extended load 402. Mesh 104 allows wind to penetrate the signaling device 100, minimizing damage to the device from prolonged use in the vehicle's slipstream.

FIG. 5 shows disabled vehicle scenario 500 in which a signaling device 100 is attached to a disabled vehicle 502 to alert drivers to the hazardous situation while the driver of the disabled vehicle makes repairs or waits for help. In this embodiment, signaling device 100 is attached to the vehicle 502 using magnets 108 located within each reinforced corner 102. Signaling device 100 is ideal for this application since it can be easily rolled up or folded and stored within a vehicle. Upon an emergency, signaling device 100 easily attaches to a vehicle as seen in FIG. 5 utilizing magnets 108 concealed within reinforced corners 102. Because the magnets 108 are concealed within the reinforced corners 102, a user may attach signaling device 100 to a vehicle without fear of scratching or otherwise harming the vehicle finish. LEDs 114 ensure that other drivers will see the disabled vehicle 502 clearly, even in low-light conditions, from any angle without having to rely on light being reflected off of the signaling device. Magnets 108 allow the signaling device 100 to be used in any situation with a metal surface, not only with automobiles. Another application would be to magnetically attach signaling device 100 to a metal highway construction sign to increase the visibility of the warning sign.

In addition to the color and light effects of signaling device 100, the device may be marked with the letters “POLICE,” “DOT,” “US ARMED FORCES,” a company name, or any other identifying insignia corresponding to the user. Alternatively, mesh 104 may be marked with messages such as “CAUTION” or “SLOW.” These identifiers and messages may be printed on the mesh 104 using a contrasting color, or may be created using reflective strip 112 or patch 208. It is to be understood that reflective strip 112 may be secured to mesh 104 in any pattern or configuration. A further embodiment for increasing the visibility of signaling device 100 includes fiber-optic thread sewn into device 100 from light assemblies 114. Fiber-optic thread receives and transmits light from light assemblies 114 or from independent light sources as known in the art and may be sewn along the edges of device 100 or in any pattern desired to provide additional illumination to device 100.

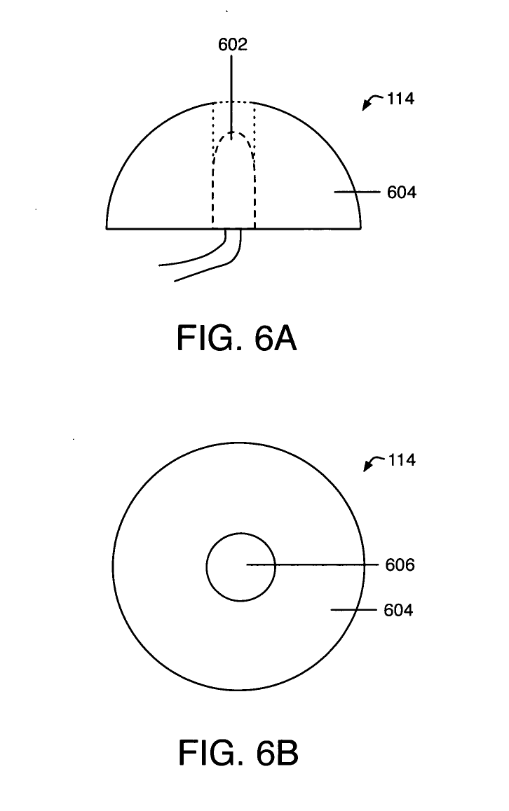

FIGS. 6A and 6B illustrate a light assembly 114 according to one embodiment of the present invention. Light assembly 114 comprises a LED 602 and protective cover 604. Protective cover 604, as seen in FIG. 6A, is dome shaped. However, it is to be understood that protective cover 604 may be any shape. Protective cover 604 is preferably made of a durable, scratch-resistant, heat-resistant material to ensure long life. Cover 604 is transparent or translucent to allow light from the LED within to emit light in all directions. Alternatively, cover 604 may allow for varying amounts of light to penetrate different portions of the cover. This feature may be useful to limit the amount of light seen by the user from one particular angle while maintaining maximum light penetration at all other viewing angles. Protective cover 604 has an aperture 606 in which the LED 602 is located. The LED 602 is recessed within the aperture 606 such that the LED does not protrude above the protective cover 604. This feature prevents the LED 602 from damage from being hit by objects or rubbed against objects separate from the device. The LED 602 and protective cover 604 are secured to a reflective strip using adhesive, heat means, or any other appropriate methods. Each protective cover 604 and corresponding LED 602 is raised so that it protrudes away from the reflective strip to which it is attached. Being raised allows for the maximum amount of light emitted from each LED to be visible. Raising the LED 602 and protective cover 604 also allows for light from the LED to be reflected off of the reflective strip to which it is attached.

The versatility of a signaling device according to embodiments of the present invention is substantially increased over typical signaling devices. Through the use of multiple mounting mechanisms, including but not limited to any combination of grommets, magnets, and hook and loop fasteners, signaling device 100 is readily displayed under a wide variety of situations. This versatility makes signaling device 100 useful as a safety device to alert others of potential dangers and also as a location marker to identify specific objects or locations for others. Signaling device 100 could even be used in children's games such as variations of the traditional “capture the flag” game. By turning on LEDs 114 or audible device 318, children who capture the flag can alert others of the victory. Further adding to the versatility of signaling device 100, reflective strip 112 is detachable, allowing for the customization of the signaling device to suit a specific purpose through the use of optional patches 208.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A signaling device comprising:
a first layer having a first reflectance;
a second layer attached to the first layer, the second layer having a second reflectance greater than the first reflectance;
a mounting mechanism located at a plurality of locations on the first layer for securing the signaling device to an object;
means for receiving a power source; and
a plurality of lights, each of the lights electrically connected to the power source receiving means.

2. The signaling device of claim 1, further comprising a plurality of reinforced corners, wherein the mounting mechanism is located at each corner of the plurality of reinforced corners.

3. The signaling device of claim 2, wherein the mounting mechanism comprises grommets.

4. The signaling device of claim 2, wherein the mounting mechanism comprises at least two mechanisms selected from a group consisting of a grommet, a magnet, and a hook and loop fastener.

5. The signaling device of claim 2, wherein the first layer is mesh, the second layer comprises reflective tape, and the plurality of lights comprise a plurality of light emitting diodes (LEDs).

6. The signaling device of claim 5, wherein each LED of the plurality of LEDs is positioned within an aperture of a raised translucent protective cover such that the LED does not protrude past an outer surface of the protective cover.

7. The signaling device of claim 6, wherein the reflective tape is detachably connected to the mesh.

8. The signaling device of claim 6, wherein the reflective tape comprises a top reflective surface and a backing and wherein the means for receiving a power source comprises electrical wiring located between the top reflective surface and the backing of the reflective tape, and wherein the power source comprises a low-profile battery located between the top reflective surface and the backing of the reflective tape.

9. The signaling device of claim 2, wherein the plurality of lights are secured to a detachable patch that displays a lighted symbol.

10. The signaling device of claim 2, wherein the plurality of lights comprise a plurality of LEDs that emit non-visible light.

11. A signaling device, comprising:
a first layer;
a second layer detachably connected to the first layer;
a mounting mechanism located at a plurality of reinforced locations on the first layer for securing the signaling device to an object;
means for receiving a power source; and
a plurality of LEDs attached to the second layer, each LED electrically connected to the power source receiving means.

12. The signaling device of claim 11, wherein the mounting mechanism comprises at least two mechanisms selected from a group consisting of a grommet, a magnet, and a hook and loop fastener.

13. The signaling device of claim 11, wherein the first layer comprises mesh, the second layer comprises reflective tape, and the plurality of lights comprise a plurality of LEDs.

14. The signaling device of claim 13, wherein each LED of the plurality of LEDs is positioned within an aperture of a raised translucent protective cover such that the LED does not protrude past an outer surface of the protective cover.

15. The signaling device of claim 13, wherein the reflective tape comprises a top reflective surface and a backing and wherein the means for receiving a power source comprises electrical wiring located between the top reflective surface and the backing of the reflective tape, and wherein the power source comprises a low-profile battery located between the top reflective surface and the backing of the reflective tape.

16. The signaling device of claim 11, wherein the plurality of lights are configured on the second layer to display a lighted symbol.

17. The signaling device of claim 11, further comprising an audible alarm.

18. The signaling device of claim 11, further comprising fiber-optic thread sewn into the first layer such that the fiber-optic thread emits light from at least one light.

19. A signaling device, comprising:
a mesh layer;
a reflective tape layer detachably connected to the mesh layer;
at least one magnet and at least one grommet fixed to the signaling device for securing the signaling device to an object;
means for receiving a power source within the reflective tape layer; and
a plurality of LEDs attached to the reflective tape layer, each LED electrically connected to the power source receiving means.

20. The signaling device of claim 19, further comprising:
a plurality of reinforced corners, wherein the at least one magnet and at least one grommet are fixed to at least one of the plurality of reinforced corners,
wherein the reflective tape comprises a top reflective surface and a backing and wherein the means for receiving a power source is electrical wiring located between the top reflective surface and the backing of the reflective tape, and wherein the power source is a low-profile battery located between the top reflective surface and the backing of the reflective tape, and
wherein each LED of the plurality of LEDs is positioned within an aperture of a raised translucent protective cover such that the LED does not protrude past an outer surface of the protective cover.
